(19) United States
(12) Patent Application Publication
(10) Pub. No.: US 2004/0218888 A1
(43) Pub. Date: Nov. 4, 2004

(54) Strain relief device for optical ribbon cables

(76) Inventors: Bassel H. Daoud, Parsippany, NJ (US); Antonio Albino Figueiredo, Lawrenceville, GA (US); Ivan Pawlenko, Holland, PA (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/427,684

(22) Filed: May 1, 2003

(51) Int. Cl. G02B 6/00

(52) U.S. Cl. 385/136

(57) ABSTRACT

Apparatus for providing strain relief of an optical ribbon cable caused by bending or other type of non-linear forces includes a base portion and a pivot portion both having a recess. The pivot portion is hingedly connected to the base portion and the recesses define a ribbon cable holding location. Compression members are provided in each of the recesses and define a gap therebetween for retaining optical fiber ribbon cables. The base portion and pivot portion are unitary and formed from a material which is non-opaque. An anchor portion is in contact with the base portion. The anchor portion has a tab member for indexing the apparatus with a support structure and a first latch member for securing the apparatus to a support structure. The hinge portion of the apparatus also has a second latch member for securing the hinge portion to the base portion.

### FIELD OF INVENTION

The present invention generally relates to optical fiber closures and, more particularly, to an optical fiber closure having improved optical fiber strain relief and fiber handling characteristics.

### BACKGROUND OF INVENTION

Optical communications refer to the medium and the technology associated with the transmission of information as light pulses. Many applications utilize an optical fiber network to establish optical communications between network locations. In order to enable optical communication and the flow of optical signals between network locations, various interconnections must be established between different optical fibers.

As the different optical fibers approach an optical termination point, the density (number) of the fibers increases. Ribbon cables, an array of for example 12 or 24 individual fibers, are commonly used in such high density applications. Unfortunately, optical ribbon cables are commonly not covered or otherwise protected by a buffer tube. This condition makes the optical fibers susceptible to damage caused by bending strain. The bend radius R_{B} of the optical fibers is an important characteristic because it corresponds to the degree of “light leakage” in each of the individual fibers. That is, as light propagates through an individual fiber, a portion of the light will travel beyond the boundaries of the fiber if R_{B} is too small (corresponding to an angle of incidence of the light upon the fiber core that is greater than the critical angle for total internal reflection of the light).

One solution to the routing and handling of ribbon cables is to use cable ties to bundle and secure a number of optical ribbon cables to one another. However, this solution does not allow for easy access to all of the ribbon cables should repair be necessary, or allow the ribbon cables to be easily secured into a predefined mounting position to ensure constant strain relief.

### SUMMARY OF THE INVENTION

These and other deficiencies of the prior art are addressed by the present invention of an apparatus for providing strain relief caused by bending or other types of non-linear forces. The apparatus includes a base portion having a recess and a pivot portion having a recess. The pivot portion is connected to the base portion and the base portion recess and the pivot portion recess define a ribbon cable holding location. The apparatus additionally has a first compression member provided in the base portion recess and a second compression member provided in the pivot portion recess. The compression members are selected from the group consisting of foam and rubber and define a gap therebetween for retaining a plurality of optical fiber ribbon cables.

The apparatus is so configured that the base portion and pivot portion are unitary and molded from a material of which is non-opaque. In one embodiment, the clear material is selected from the group consisting of a polymer 12-based material.

The apparatus also has an anchor portion in contact with the base portion. The anchor portion has a tab member for indexing the apparatus with a support structure and a first latch member for securing the apparatus to a support structure. The hinge portion of the apparatus also has a second latch member for securing the hinge portion to the base portion. In one embodiment of the invention, the anchor portion has a flat top surface. In a second embodiment of the invention, the anchor portion has a circular shaped top surface.

### BRIEF DESCRIPTION OF THE DRAWINGS

The teachings of the present invention can be readily understood by considering the following detailed description in conjunction with the accompanying drawings, in which:

FIG. 1 depicts a side view (with partial cross-sectional view) of the strain relief device of the subject invention;

FIG. 2 depicts a top view of the strain relief device seen in FIG. 1;

FIG. 3 depicts a side view of the strain relief device shown in FIG. 1 with a pivot portion in an open position;

FIG. 4 depicts the strain relief device of FIG. 1 with the pivot portion in a closed position and securing a plurality of optical ribbon cables; and

FIG. 5 depicts a side view of a second embodiment of the invention as seen along lines 5-5 of FIG. 2.

To facilitate understanding, identical reference numerals have been used, where possible, to designate identical elements that are common to the figures.

### DETAILED DESCRIPTION OF THE INVENTION

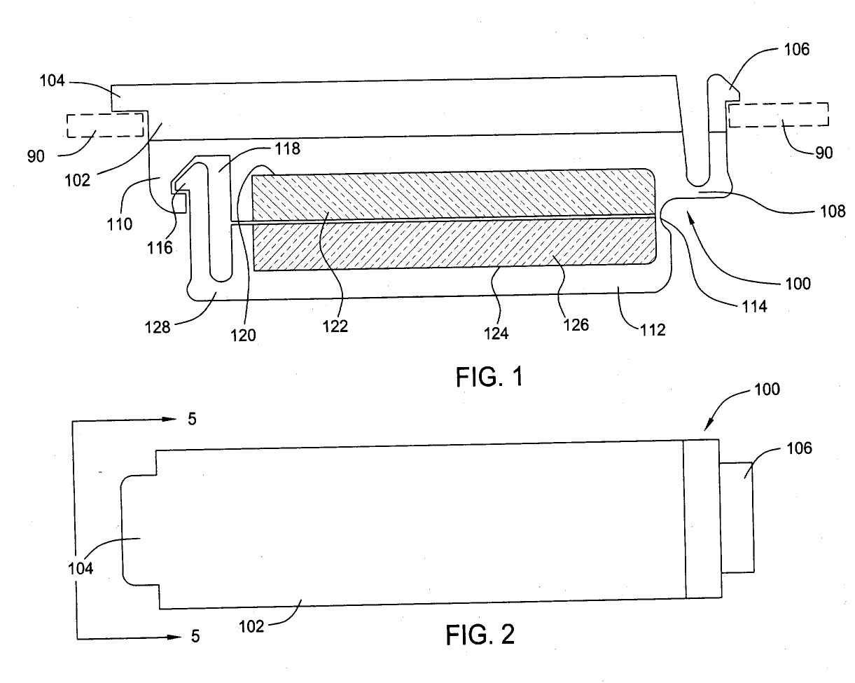

FIG. 1 depicts a side view (with partial cross-sectional view) of a strain relief device 100 of the subject invention. FIG. 2 is a top view of the strain relief device 100 and the reader is invited to view both figures concurrently with this description. Specifically, the strain relief device 100 is shown arranged and secured to a frame member 90 (shown in a broken line format as it is not part of the specific invention) as one exemplary use of the subject invention. Those skilled in the art will realize that the strain relief device 100 can be configured in a variety of different ways so as to securely fit in any number of frames, shelves or the like used in organizing optical fibers ribbon cables in an optical communications network and/or any other system components that require neat, organized and secure arrangment. For the sake of clarity, the frame 90 is not shown in FIG. 2.

The strain relief device 100 includes an anchor portion 102 upon which the rest of the device is built. The anchor portion 102 includes a rear tab 104 and a first latch (i.e., a front latch) 106. The rear tab 104 allows for registration and positive positioning of the strain relief device 100 in an opening in the frame 90. The front latch 106 allows for detachably securing the device 100 to the frame 90. In other words, the front latch 106 can be operated any number of times to allow for the initial installation of the strain relief device 100 onto the frame 90 and subsequent detachments and reattachments of same for purposes of inspection, repair and the like of either the device or ribbon cables secured therein (discussed in detail below).

Adjoining the anchor portion 102 is a base portion 110. The base portion 110 includes a first flexible hinge 108 which transitions into the front latch 106 as it extends upwards towards the anchor portion 102. The strain relief mechanism 100 also has a pivot portion 112 that is hingedly connected to the base portion 110 at second flexible hinge 114. Pivot portion 112 also includes a second latch (i.e., a pivot portion latch) 116 that transitions from a third flexible hinge 128. The second latch 116 is locked into place in an enclosure 118 in the base portion 110 especially designed and configured to receive the pivot portion latch 116. One skilled in the art will realize that locking of the pivot portion to the base portion can also be easily attained by reversing the orientation of the second latch 116 and the enclosure 118. That is, if the relevant portions of the strain relief device 100 were molded, or otherwise formed, “in reverse”, the enclosure 118 would be in the pivot portion 112 and the second latch would extend from the base portion 110 yet, the functionality would be identical.

The various portions of the strain relief device 100 are fabricated from a polymer-12 based material. The material can be opaque or non-opaque. In one embodiment, the strain relief device 100 is fabricated from Grilamid, which is a clear plastic material manufactured and sold by K-Mac Plastics of Kentwood, Mich. One skilled in the art will realize that other types of materials are suitable for the application. Such materials are preferably non-opaque (so as to facilitate viewing of the fibers contained therein) and relatively durable (so as to withstand handling and installation into supporting frameworks and opening and closing of the device). A material such as Grilamid is known to also have desirable “living hinge” characteristics so as to provide the appropriate functionality to first hinge 108 and second hinge 114. For example, hinges 108 and 114 and the portions on the device 100 to which they transition are all formed as a single, unitary piece so as to reduce the number of components of the subject device 100. For example, first hinge 108 and second hinge 114 are relatively thin areas of material of which the strain relief device 100 is constructed.

One skilled in the art will understand that the terminology “living hinge” means making second hinge 114 substantially thin enough (and in one embodiment approximately 10 mil) so as to provide hinged motion between the base portion 110 and the pivot portion 112 yet remain durable enough to maintain structural integrity of the overall device. An appropriate thickness of first hinge 108 will allow it to operate repeatedly in the desired manner. It will also be understood to one skilled in the art that a thin layer material version of the strain relief device 100 is not the only way hinged attachment of these components can be made and that other suitable materials or methods of attachment are possible. Such suitable alternate materials can be selected from the group consisting of nylon and polypropylene as these materials have suitable living hinge characteristics. Additionally, the hinge design can also be a standard detachable hinge arrangement.

Base portion 110 is further provided with a base portion recess 120. Similarly, pivot portion 112 is provided with a pivot portion recess 124. Both the base portion recess 120 and the pivot portion recess 124 contain a compression member therein. Specifically, a first compression member 122 is sized to fit in base portion recess 120 and second compression member 126 is sized to fit in pivot portion recess 124. Each of the compression members 122 and 126 are fabricated from a highly elastic and high friction type material so as to allow the necessary amount of compression to hold ribbon cables therebetween while remaining sufficiently durable so as to not lose their strength or compressive abilities over time. In one embodiment of the invention, the compression members 122 and 126 are fabricated from materials selected from the group consisting of rubber and foam. In one particular embodiment of the subject invention, the compression members 122 and 126 are selected from the group consisting of neoprene foam and rubber foam.

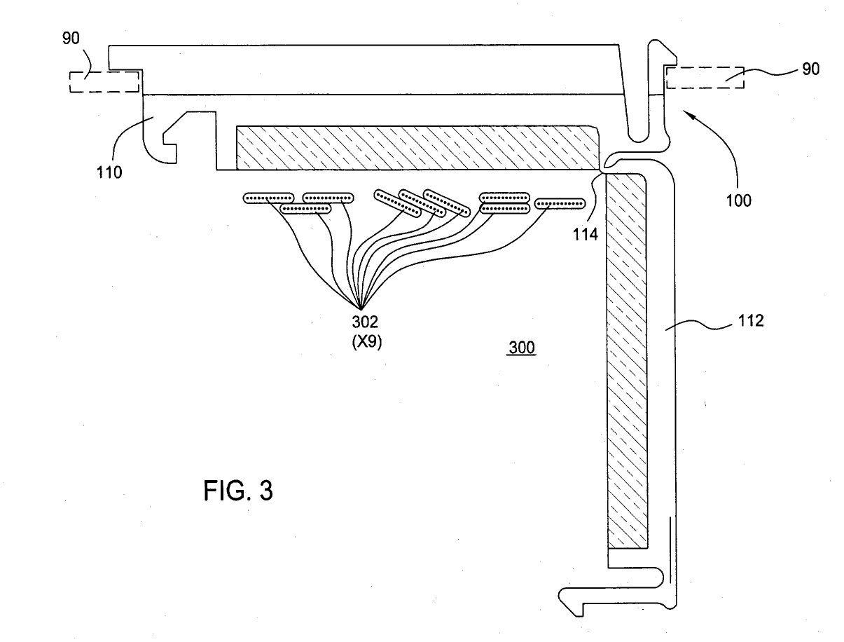

FIG. 3 depicts the strain relief device 100 of the subject invention wherein the hinge portion 112 is delatched and swung away from the base portion 110. In this manner, one or more ribbon cables can be arranged in an opening 300 provided between the stationary base portion 110 and the hinge portion 112. Specifically, in FIG. 3 a plurality of ribbon cables 302 (viewed cross-sectionally to see respective pluralities of individual optical fibers contained therein) are positioned into opening 300, yet not completely secured to the strain relief device 100.

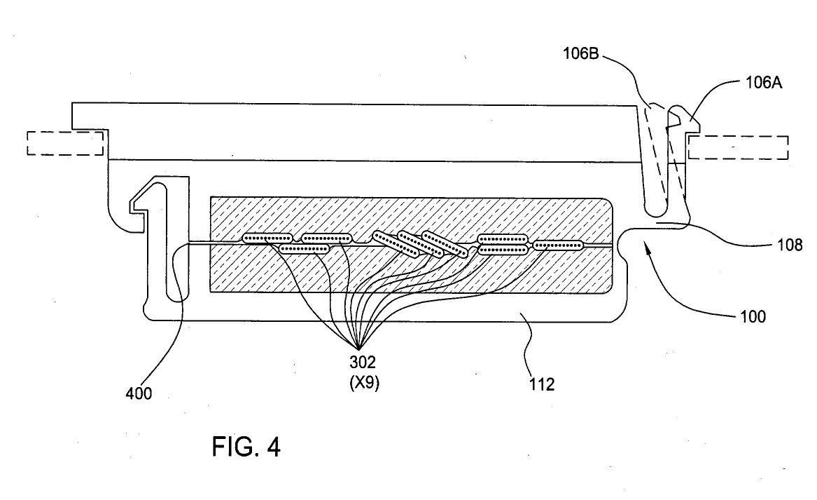

FIG. 4 depicts the strain relief device 100 of FIG. 1 with the pivot section 112 in a closed position and securing the plurality of optical ribbon cables 302. Specifically, once the hinge portion 112 of the strain relief device 100 is latched into place, the opening 300 which receives the plurality of ribbon cables 302 is narrowed into a gap 400 between first and second compression members 122 and 126, respectively. Accordingly, the plurality of ribbon cables 302 are secured into position by virtue of the compressive forces of the first and second compression members 122 and 126, respectively, and/or neighboring ribbon cables 302. It should be noted that the ribbon cables 302 do not need to be arranged in any specific order or arrangement. That is, the compressive forces generated by the strain relief device 100 do not damage the ribbon cables 302 and tend to substantially immobilize the ribbon cables 302 from directional movements that may cause the damaging bends and/or strain.

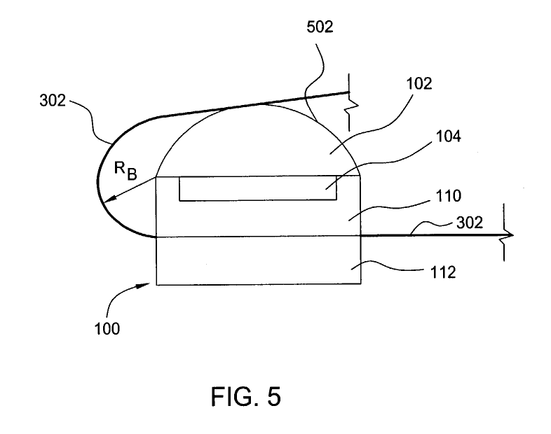

FIG. 5 depicts a side elevation view of a second embodiment of the strain relief apparatus 100 as viewed along lines 5-5 of FIG. 2. Specifically, FIGS. 1-4 depict the first embodiment of the apparatus 100 as having a flat topped anchor portion 102. FIG. 5 depicts the apparatus 100 as having a domed anchor portion 102. In detail, strain relief apparatus 100 is shown with the base portion 110 and pivot portion 112 clamping a plurality of ribbon cables 302 in place. The anchor portion 102 includes a circular or domed shaped surface 502 which further increases strain relief of the ribbon cables 302. As the ribbon cables 302 exit the strain relief apparatus 100, the ribbon cables 302 are wrapped around the domed top surface 502 which provides an sufficiently large bend radius R_{B} to further prevent damage or excessive signal degradation.

For sake of clarity on the use and operation of the “living hinges,” the operation of first latch 106 is depicted. Specifically, first hinge 108, being a “living hinge” type arrangement, allows flexibility of the latch 106 about the hinge 108. Specifically, first latch 106 is shown in a locked first position (106A) and by virtue of the flexibility of first hinge 108, it is possible to move first latch 106 into an unlocked position (106B). This unlocked position 106B allows the strain relief device 100 to be detached from the frame or shelf 90 so that it can be inspected and/or replaced as necessary. It will be noted that second latch 116 operates in substantially the same manner as first latch 108 by virtue of the “living hinge” capabilities of third hinge 128 as well.

The advantages of the subject invention are readily realized. Specifically, the unitary construction of the strain relief device 100 facilitates handling (i.e., opening and closing) of the strain relief device 100 without the problem of misalignment of the base portion 110 and the hinge portion 112. The total number of molds to create the device (and parts resulting therefrom) is reduced from at least two to one. The strain relief device 100 of the subject invention also has a low profile which allows for mounting numerous ribbon cables 302 simultaneously. The invention is sized so as to fit and be installed into existing optical communication network components (i.e., high identity applications including Lambda routers, high density optical closures, fiber cross connect shelves such as LGX shelves, LIUs and the like). Additionally, the device requires no additional fasteners for installing or subsequent removal and reinstallation. If the preferred clear material is used for to fabricate the device, visual inspection is facilitated without having to handle the device of the fibers contained therein. Lastly, the design of the device allows for strain relieving both 12 fiber or 24 fiber optical ribbon cables. Accordingly, this technology is adaptable to older optical communication systems as well as state-of-the-art equipment.

Although various embodiments that incorporate the teachings of the present invention have been shown and described in detail herein, those skilled in the art can readily devise many other varied embodiments that still incorporate these teachings.

What is claimed is:

1. An apparatus comprising:
a base portion having a recess; and
a pivot portion having a recess, the pivot portion unitary with the base portion;
said base portion recess and said pivot portion recess defining a holding location;
and a latch member for securing the hinge portion and the base portion.

2. The apparatus of claim 1 further comprising a first compression member provided in the base portion recess and a second compression member provided in the pivot portion recess.

3. The apparatus of claim 2 wherein the first compression member and second compression member are selected from the group consisting of foam and rubber.

4. The apparatus of claim 2 wherein the first compression member and second compression member define a gap therebetween for retaining one or more optical fiber ribbon cables.

5. The apparatus of claim 1 further comprising an anchor portion in contact with the base portion.

6. The apparatus of claim 5 wherein the anchor portion further comprises a tab member for indexing the apparatus with a support structure.

7. The apparatus of claim 5 wherein the anchor portion further comprises a first latch member for securing the apparatus to a support structure.

8. The apparatus of claim 5 wherein the anchor portion has a flat surface.

9. The apparatus of claim 5 wherein the anchor portion has a circular surface.

10. The apparatus of claim 1 wherein the material of which the apparatus is comprised is selected from the group consisting of opaque and non-opaque materials.

11. The apparatus of claim 10 wherein the material is selected from the group consisting of a polymer 12-based material.

12. The apparatus of claim 10 wherein the material is a clear plastic material.

13. The apparatus of claim 1 wherein the latch member is disposed on the pivot portion and is received in an enclosure in the base portion.

14. The apparatus of claim 1 wherein the latch member is disposed on the base portion and is received in an enclosure in the pivot portion.
